(19) United States
(12) Patent Application Publication
(10) Pub. No.: US 2023/0059897 A1
(43) Pub. Date: Feb. 23, 2023

(54) SYSTEM AND METHOD FOR VEHICLE-TO-EVERYTHING (V2X) COLLABORATIVE PERCEPTION

(71) Applicant: Lear Corporation, Southfield, MI (US)

(72) Inventors: Radovan MIUCIC, Beverly Hills, MI (US); Samer RAJAB, Novi, MI (US); Vamsi PEDDINA, Windsor (CA); Douglas MOELLER, Santa Rosa, CA (US)

(73) Assignee: Lear Corporation, Southfield, MI (US)

(21) Appl. No.: 17/661,425

(22) Filed: Apr. 29, 2022

Related U.S. Application Data
(60) Provisional application No. 63/260,215, filed on Aug. 12, 2021.

(51) Int. Cl. G08G 1/16; H04W 4/44; H04W 4/90

(52) U.S. Cl. CPC G08G 1/163; G08G 1/166; H04W 4/44; H04W 4/90

(57) ABSTRACT

A system, method, and non-transitory computer readable medium for collaborative perception among vehicles using vehicle-to-everything (V2X) communications. The system includes a V2X communication system, a sensor system, and a controller to be mounted in the host vehicle. The controller is configured to receive data from the sensor system of the host vehicle and detect a vulnerable road user based on the received sensor data. The controller is further configured to transmit, via the host vehicle V2X communication system, V2X communications based on the received sensor system data to a first remote vehicle equipped with a V2X communication system, the V2X communications including information relating to the detected vulnerable road user.

### CROSS-REFERENCE TO RELATED APPLICATION

The present application claims the benefit of U.S. Provisional Patent Application No. 63/260,215 filed on Aug. 12, 2021, the disclosure of which is hereby incorporated by reference herein in its entirety.

### TECHNICAL FIELD

The following relates to a system and method for collaborative perception among vehicles using Vehicle-to-Everything (V2X) communications.

### BACKGROUND

Safe driving of motor vehicles is highly regarded and desired among the public, by governmental authorities, and in the automotive industry to reduce fatalities, injuries, and property damage. In the automotive industry, systems to assist driver operation of a vehicle, provide information to a driver, and/or enhance or improve driving safety are well known. Such systems include, for example, automated driver assistance systems (ADAS), telematics control units (TCU), vehicle-to-everything or vehicle-to-anything (V2X) communication systems, and other safety related applications.

### SUMMARY

According to one non-limiting exemplary embodiment described herein, a system is provided for collaborative perception among vehicles using vehicle-to-everything (V2X) communications. The system comprises a V2X communication system to be mounted in a host vehicle, a sensor system to be mounted in the host vehicle, and a controller to be mounted in the host vehicle. The controller is configured to receive data from the sensor system of the host vehicle and to detect a vulnerable road user based on the received sensor data. The controller of the host vehicle is further configured to transmit, via the host vehicle V2X communication system, V2X communications based on the received sensor system data to a first remote vehicle equipped with a V2X communication system, the V2X communications comprising information relating to the detected vulnerable road user.

According to one non-limiting exemplary embodiment described herein, a method is provided for collaborative perception among vehicles using vehicle-to-everything (V2X) communications. The method comprises receiving data from a sensor system mounted in a host vehicle, detecting a vulnerable road user based on the received sensor data, and transmitting, via a V2X communication system of the host vehicle, V2X communications based on the received sensor system data to a first remote vehicle equipped with a V2X communication system, the V2X communications comprising information relating to the detected vulnerable road user.

According to yet another non-limiting exemplary embodiment described herein, a non-transitory computer readable medium is provided having stored computer executable instructions for collaborative perception among vehicles using vehicle-to-everything (V2X) communications, including a host vehicle comprising a V2X communication system, a sensor system, and a controller. Execution of the instructions causes the controller to receive data from the sensor system, detect a vulnerable road user based on the received sensor data, and transmit, via the V2X communication system, V2X communications based on the received sensor system data to a first remote vehicle equipped with a V2X communication system, the V2X communications comprising information relating to the detected vulnerable road user.

A detailed description of these and other non-limiting exemplary embodiments of collaborative perception among vehicles using vehicle-to-everything (V2X) communication is set forth below together with the accompanying drawings.

### BRIEF DESCRIPTION OF THE DRAWINGS

FIG. 1 is an exemplary simplified illustration of collaborative perception among vehicles using V2X communications according to the present disclosure;

FIG. 2 is an exemplary simplified block diagram of an interface for a sensor and on-board unit in a host vehicle equipped for V2X communication according to the present disclosure;

FIG. 3 is an exemplary video display of objects detected by a host vehicle equipped for V2X communications according to the present disclosure;

FIGS. 4A and 4B are exemplary video displays illustrating collaborative perception from participant vehicle perspectives according to the present disclosures;

FIG. 5 is an exemplary simplified flowchart illustrating an exemplary process flow of collaborative perception among vehicles using V2X communications according to the present disclosure;

FIGS. 6A and 6B are exemplary simplified block diagrams of exemplary exclusion scenarios for collaborative perception among vehicles using V2X communications according to the present disclosure;

FIGS. 7A-7E are exemplary simplified block diagrams illustrating heading computation for remote objects for collaborative perception among vehicles using V2X communications according to the present disclosure;

FIG. 8 is an exemplary simplified block diagram illustrating collaborative perception stability and Basic Safety Message (BSM), surrogate BSM, Cooperative/Collaborative/Collective Perception Message (CPM), or any other standardized message (e.g., Cooperative Awareness Message (CAM) in Europe) duplication avoidance according to the present disclosure;

FIG. 9 is exemplary simplified block diagram illustrating a V2X BSM generated remote object position in comparison to a Collaborative Perception (CP) Perceived Object Container (POC) according to the present disclosure;

FIG. 10 is an exemplary graph of Collaborative Perception (CP) to V2X distance data for collaborative perception stability and basic safety message duplication avoidance according to the present disclosure; and

FIGS. 11A-11C are exemplary simplified block diagrams illustrating exemplary vulnerable road user (VRU) scenarios according to the present disclosure.

### DETAILED DESCRIPTION

It is noted that detailed non-limiting embodiments are disclosed herein. However, it is to be understood that the disclosed embodiments are merely exemplary and may take various and alternative forms. The figures are not necessarily to scale, and features may be exaggerated or minimized to show details of particular components. Therefore, specific structural and functional details disclosed herein are not to be interpreted as limiting, but merely as a representative basis for teaching one skilled in the art.

With reference to the Figures, a more detailed description of non-limiting exemplary embodiments of a system and method for collaborative perception among vehicles using V2X communications will be provided. For ease of illustration and to facilitate understanding, like reference numerals may be used herein for like components and features throughout the drawings.

Safe driving of motor vehicles is highly regarded and desired among the public, by governmental authorities, and in the automotive industry to reduce fatalities, injuries, and property damage. In the automotive industry, systems to assist driver operation of a vehicle, provide information to a driver, and/or enhance or improve driving safety are well known. Such systems include, for example, automated driver assistance systems (ADAS), telematics control units (TCU), vehicle-to-everything or vehicle-to-anything (V2X) communication systems, and other safety related applications.

In that regard, vehicle-to-everything (V2X) communication is the passing of information from a vehicle to any entity that may affect the vehicle, and vice versa. V2X is a vehicular communication system that incorporates or includes other more specific types of communication such as Vehicle-to-Infrastructure (V2I), Vehicle-to-Network (V2N), Vehicle-to-Vehicle (V2V), Vehicle-to-Pedestrian (V2P), Vehicle-to-Motorcycle (V2M), Vehicle-to-Bicycle (V2B), and Vehicle-to-Device (V2D). V2X communication is designed to improve road safety, traffic efficiency, and energy savings, as well as vehicle occupant safety, information, and comfort, and may be implemented using Dedicated Short Range Communication (DSRC) Wireless Local Area Network (WLAN) technology, or cellular technology, which may also be referred to as Cellular Vehicle-to-everything (CV2X). V2X communication may use WLAN technology and work directly between vehicles, which form a vehicular ad-hoc network as two V2X transmitters come within each range of each other. Hence it does not require any infrastructure for vehicles to communicate, which can improve safety in remote or little developed areas. WLAN is particularly well-suited for V2X communication, due to its low latency. It transmits messages known as Cooperative Awareness Messages (CAM) and Decentralized Environmental Notification Messages (DENM) or Basic Safety Message (BSM). The data volume of these messages is very low. The radio technology is part of the WLAN 802.11 family of standards developed by the Institute of Electrical and Electronics Engineers (IEEE) and known in the United States as Wireless Access in Vehicular Environments (WAVE) and in Europe as ITS-G5.

In general, the present disclosure describes a system and method for collaborative perception among vehicles using V2X (V2X) (i.e., vehicle-to-anything or vehicle-to-everything) messages or communications and V2X communication systems. In that regard, the collaborative perception system and method of the present disclosure may use vehicle on-board sensors (e.g., camera vision, LiDAR, Radar) to detect objects/road users and use V2X to incorporate them into V2X network communications. The collaborative perception system and method of the present disclosure may detect non V2X equipped objects that are road users, share the detected road users via V2X with other V2X equipped road users, and/or run cooperative applications with the newly detected road users, such as collision avoidance, automatic driver assist systems, intersection movement assist systems, and any others. In such a fashion, the collaborative perception system and method of the present disclosure may bridge the gap from very few vehicles equipped with V2X to most vehicles being equipped with V2X, as well as incorporate other road users (such as pedestrians and bicycles) into a V2X communications network.

The collaborative system and method of the present disclosure utilize vehicles connected to each other as well as with infrastructure (e.g., a Road-Side Unit (RSU)) and that share information wirelessly using DSRC/Cellular-V2X. In V2X communications, vehicles with On-Board Units (OBU) broadcast Basic Safety Messages (BSM) periodically, e.g., 10 times per second, which include position, speed, heading, and other information. Once again, such V2X communication is accomplished utilizing radio frequency signals for transmission of data according to known techniques, protocols, and/or standards associated with such communication, as well as antennas configured for transmitting and receiving DSRC WLAN or cellular radio frequency signals.

As those skilled in the art will understand, the communication units (including transmitters, receivers, and antennas), controllers, control units, systems, subsystems, units, modules, interfaces, sensors, devices, components, or the like utilized for, in, or as part of V2X communication systems and/or otherwise described herein may individually, collectively, or in any combination comprise appropriate circuitry, such as one or more appropriately programmed processors (e.g., one or more microprocessors including central processing units (CPU)) and associated memory, which may include stored operating system software and/or application software (i.e., computer executable instructions) executable by the processor(s) for controlling operation thereof and for performing the particular algorithm or algorithms represented by the various functions and/or operations described herein, including interaction between and/or cooperation with each other. One or more of such processors, as well as other circuitry and/or hardware, may be included in a single Application-Specific Integrated Circuitry (ASIC), or several processors and various circuitry and/or hardware may be distributed among several separate components, whether individually packaged or assembled into a System-on-a-Chip (SoC).

As is known to those of ordinary skill in the art (see, e.g., SAE J2945), all V2X communications may include a Basic Safety Message (BSM) or a Cooperative Awareness Message (CAM). As part of each BSM, a V2X system must transmit (i) Longitudinal and latitudinal location within 1.5 meters of the actual position at a Horizontal Dilution of Precision (HDOP) smaller than 5 within the 1 sigma absolute error; and (ii) Elevation location within 3 meters of the actual position at a Horizontal Dilution of Precision (HDOP) smaller than 5 within the 1 sigma absolute error. As part of each BSM, a V2X (e.g., DSRC) device must also transmit speed, heading, acceleration, and yaw rate. Speed must be reported in increments of 0.02 m/s, within 1 km/h (0.28 m/s) of actual vehicle speed. Heading must be reported accurately to within 2 degrees when the vehicle speed is greater than 12.5 m/s (˜28 mph), and to within 3 degrees when the vehicle speed is less than or equal to 12.5 m/s. Additionally, when the vehicle speed is below 1.11 m/s (˜2.5 mph), the V2X device must latch the current heading and transmit the last heading information prior to the speed dropping below 1.11 m/s. The V2X device is to unlatch the latched heading when the vehicle speed exceeds 1.39 m/s (˜3.1 mph) and transmit a heading within 3 degrees of its actual heading until the vehicle reaches a speed of 12.5 m/s where the heading must be transmitted at 2 degrees accuracy of its actual heading. Horizontal (longitudinal and latitudinal) acceleration must be reported accurately to 0.3 m/s², and vertical acceleration must be reported accurately to 1 m/s². Yaw rate must be reported accurately to 0.5 degrees/second.

In addition, a Path History data frame will be transmitted as a required BSM element at the operational frequency of the BSM transmission. The Path History data frame requires a history of past vehicles Global Navigation Satellite System (GNSS) locations as dictated by GNSS data elements including Coordinated Universal Time (UTC) time, latitude, longitude, heading, elevation sampled at a periodic time interval of 100 ms and interpolated in-between by circular arcs, to represent the recent movement of the vehicle over a limited period of time or distance. Path History points should be incorporated into the Path History data frame such that the perpendicular distance between any point on the vehicle path and the line connecting two consecutive PH points shall be less than 1 m. The number of Path History points that a vehicle should report is the minimum number of points so that the represented Path History distance (i.e., the distance between the first and last Path History point) is at least 300 m and no more than 310 m, unless initially there is less than 300 m of Path History. If the number of Path History points needed to meet both the error and distance requirements stated above exceeds the maximum allowable number of points (23), the Path History data frame shall be populated with only the 23 most recent points from the computed set of points. A Path History data frame shall be populated with time-ordered Path History points, with the first Path History point being the closest in time to the current UTC time, and older points following in the order in which they were determined.

Path Prediction trajectories will also be transmitted as a required BSM element at the operational frequency of the BSM transmission. Trajectories in a Path Prediction data frame are represented, at a first order of curvature approximation, as a circle with a radius, R, and an origin located at (0,R), where the x-axis is aligned with the perspective of the transmitting vehicle and normal to the vertical axis of the vehicle. The radius, R, will be positive for curvatures to the right when observed from the perspective of the transmitting vehicle, and radii exceeding a maximum value of 32,767 are to be interpreted as a “straight path” prediction by receiving vehicles. When a DSRC device is in steady state conditions over a range from 100 m to 2,500 m in magnitude, the subsystem will populate the Path Prediction data frame with a calculated radius that has less than 2% error from the actual radius. For the purposes of this performance requirement, steady state conditions are defined as those which occur when the vehicle is driving on a curve with a constant radius and where the average of the absolute value of the change of yaw rate over time is smaller than 0.5 deg/s². After a transition from the original constant radius (R1) to the target constant radius (R2), the subsystem shall repopulate the Path Prediction data frame within four seconds under the maximum allowable error bound defined above.

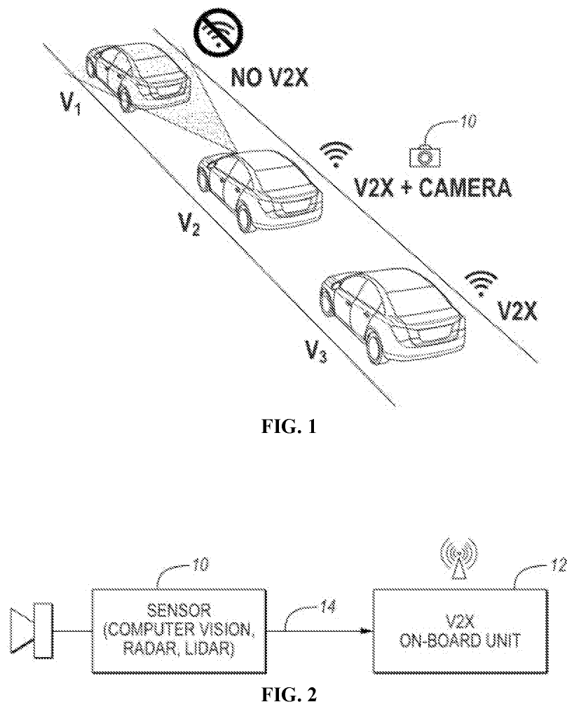

Referring now to FIG. 1, an exemplary simplified illustration of collaborative perception among vehicles using V2X communications according to the present disclosure is shown. As seen therein, using on-board vehicle sensors on Host Vehicle (V₂), such as a camera 10, RADAR, etc., Host Vehicle (V₂) infers information about surrounding vehicle (V₁), which is not equipped with a V2X communication system. The V2X on-board unit (OBU) (not shown) on Host Vehicle (V₂) transmits one or more Basic Safety Messages (BSM) on behalf of the surrounding vehicle (V₁). As a result, to all other vehicles equipped with V2X communication systems (e.g., V₃), it is looks like (V₁) is equipped with V2X communication.

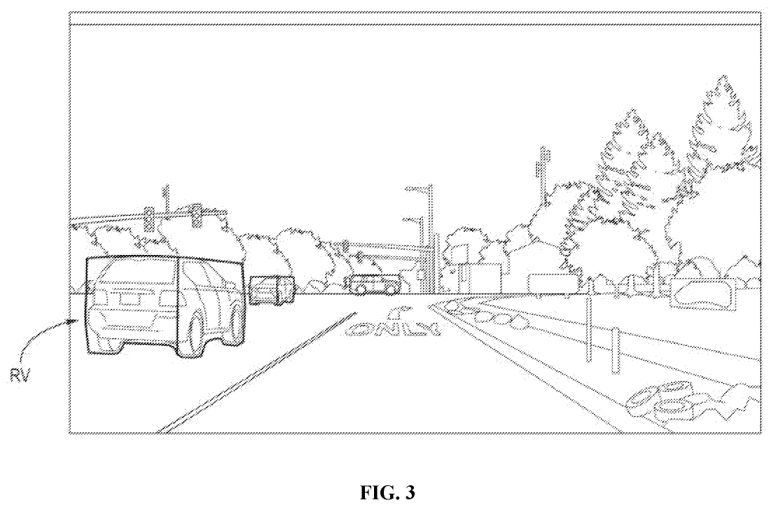

FIG. 2 is an exemplary simplified block diagram of an interface for a sensor and on-board unit in a host vehicle equipped for V2X communication according to the present disclosure. As seen therein, such a host or ego vehicle includes a V2X OBU 12 that is configured to transmit or send out host or ego vehicle BSMs. According to the present disclosure, the V2X OBU is also configured to transmit or send out messages (proxy BSMs and custom messages) based on the data received from one or more sensors, which may include a computer vision system, RADAR, LiDAR, and/or other sensors 10. More specifically, a computer vision system 10 may detect objects and send messages (e.g., over ethernet or the host vehicle controller area network (CAN) 14) to the V2X OBU with the following information: detected object type (e.g., passenger vehicle, truck, pedestrian, motorcycle, bicycle, traffic light, etc.); relative position of detected objects; estimated speed and/or acceleration of detected objects; estimated heading of detected objects; other attributes such as turn signal, interpreted hand gesture, open door, etc.

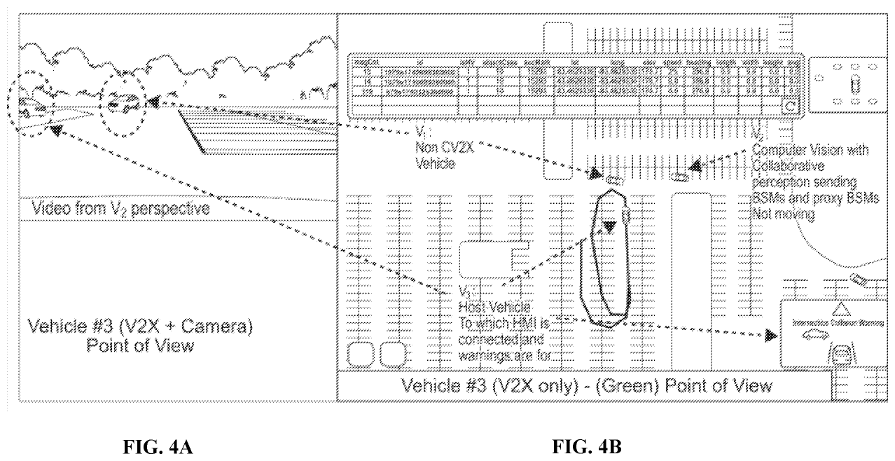

In that regard, FIG. 3 is an exemplary video display of objects, such as remote vehicles (RV) detected by a host vehicle (HV) equipped for V2X communications according to the present disclosure. For each detected object the computer vision system may provide: Time Stamp; Frame #; Object ID; Object Class; Bearing; Orientation; Distance X; Distance Y; Speed X; Speed Y; Acceleration X; Acceleration Y; and Confidence score. It should be noted that the Bearing; Orientation; Distance X; Distance Y; Speed X; Speed Y; Acceleration X; and Acceleration Y parameters may be in the camera coordinate system.

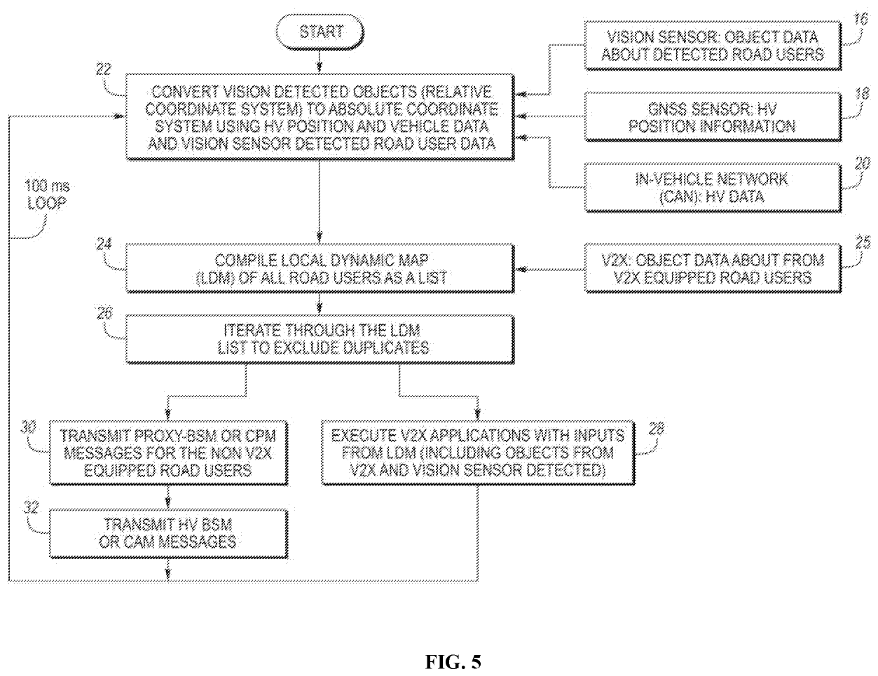

FIGS. 4A and 4B are exemplary video displays illustrating collaborative perception from participant vehicle perspectives according to the present disclosures. As seen therein, vehicle V₁ is not equipped with a V2X communication system. Vehicle V₂ is equipped with a V2X communication system and a computer vision system, including, e.g., a camera. FIG. 4A is an exemplary video display from the perspective or point of view of vehicle V₂, while FIG. 4B is an exemplary video display from the perspective or point of view of vehicle V₃ (aerial, top, or birds-eye-view), which is also equipped with a V2X communication system. According to the collaborative perception system and method of the present disclosure, vehicle V₂ sends its own BSMs as well as proxy BSMs on behalf of V₁ to vehicle V₃. In such a fashion, even though vehicle V₁ is not equipped with a V2X communication system, by virtue of the proxy BSMs sent by vehicle V₂ on behalf of vehicle V₁, vehicle V₃ is nevertheless made aware of the presence and the above-noted parameters of vehicle V₁, which presence and parameters can be used to provide an intersection collision warning or intersection movement assist (IMA) to the driver of vehicle V₃.

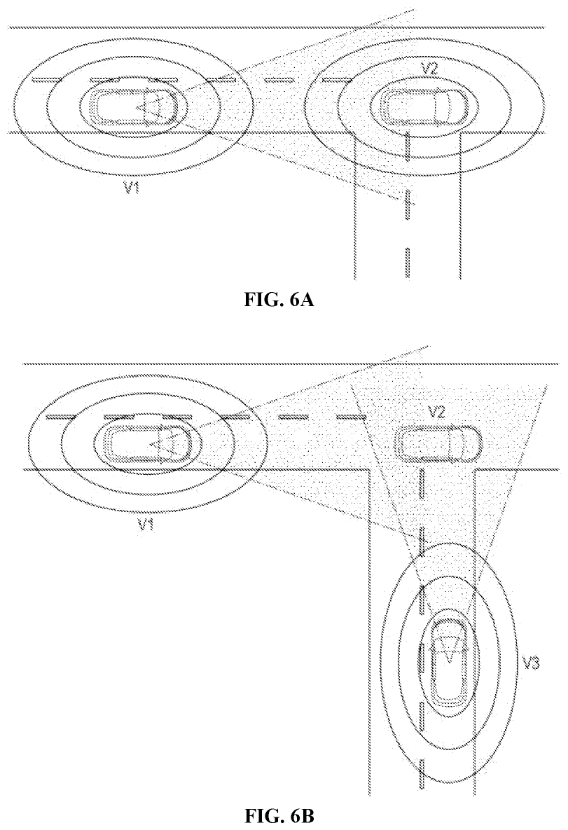

Referring now to FIG. 5, an exemplary simplified flowchart illustrating an exemplary process flow of collaborative perception among vehicles using V2X communications according to the present disclosure is shown. As seen therein, according to the collaborative perception system and method of the present disclosure, using object data about detected road users 16 from a vision sensor, host vehicle position information 18 from a GNSS (e.g., GPS) sensor, and host vehicle data 20 from an in-vehicle network (e.g., CAN), a host vehicle may convert 22 vision detected objects from a relative (i.e., camera) coordinate system to an absolute coordinate system based on the host vehicle position 18, host vehicle data 20, and detected road user data 16. Thereafter, the host vehicle may compile 24 a local dynamic map (LDM) of all road users as a list using object data 25 from V2X equipped road users and iterate 26 through the LDM to exclude duplicates. The host vehicle may then execute V2X applications 28 with inputs from the LDM, including objects detected from V2X communications 25 as well as objects detected by vision sensor(s) 16. The host vehicle may also transmit 30 proxy-BSM or Collective Perception Messages (CPM) for road users not equipped with V2X communication systems and also transmit 32 host vehicle BSMs or Cooperative Awareness Messages (CAM). Thereafter, process flow may return to the step of converting 22 vision detected objects from a relative (i.e., camera) coordinate system to an absolute coordinate system based on the host vehicle position 18, host vehicle data 20, and detected road user data 16. In that regard, the process flow may loop or repeat every 100 milliseconds

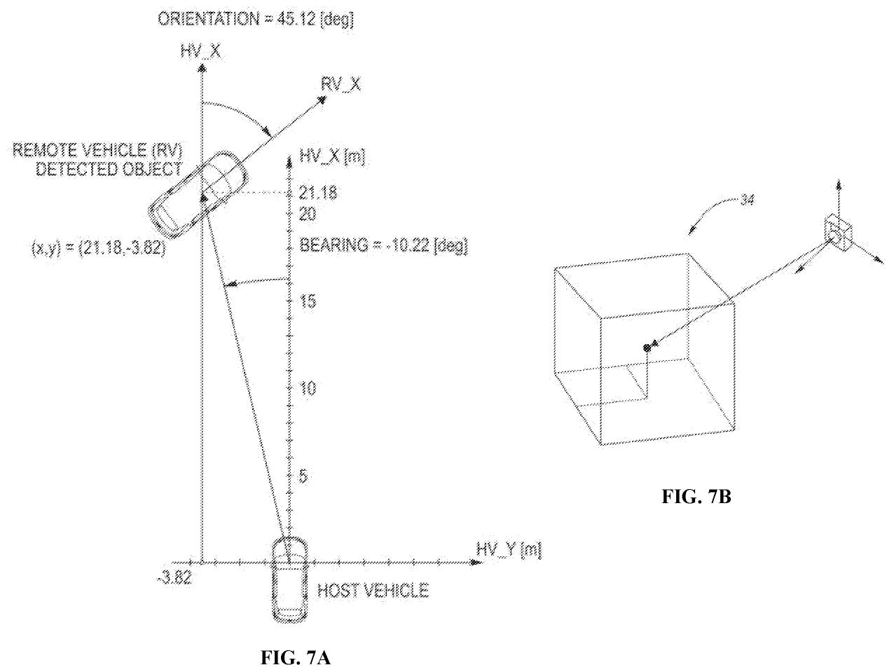

FIGS. 6A and 6B are exemplary simplified block diagrams of exemplary exclusion scenarios for collaborative perception among vehicles using V2X communications according to the present disclosure. In a first exemplary exclusion scenario shown in FIG. 6A, vehicle V1 is equipped with V2X and vision systems and vehicle V2 is equipped with a V2X system only. According to the collaborative perception system and method of the present disclosure, if vehicle V1 detects vehicle V2 with both vision sensor and V2X device, vehicle V1 will not send out proxy-BSMs on behalf of vehicle V2. Internally, vehicle V1 may combine vision sensor and V2X detections via sensor fusion for the purposes of increasing accuracy of detected objects.

In a second exemplary exclusion scenario shown in FIG. 6B, vehicles V1 and V3 are equipped with V2X and vision systems and vehicle V2 has no V2X system. According to the collaborative perception system and method of the present disclosure, when both vehicles V1 and V3 detect vehicle V2 using visual sensor, if vehicles V1 and V3 are within communication range, arbitration must take place to determine which vehicle gets to transmit proxy-BSMs on behalf of vehicle V2. According to a first option, whichever vehicle (V1 or V2) sends out the first proxy-BSM wins and continues to send out information about vehicle V2. According to a second option, that vehicle (V1 or V2) which is closer to vehicle V2 wins and continues to send out information about V2.

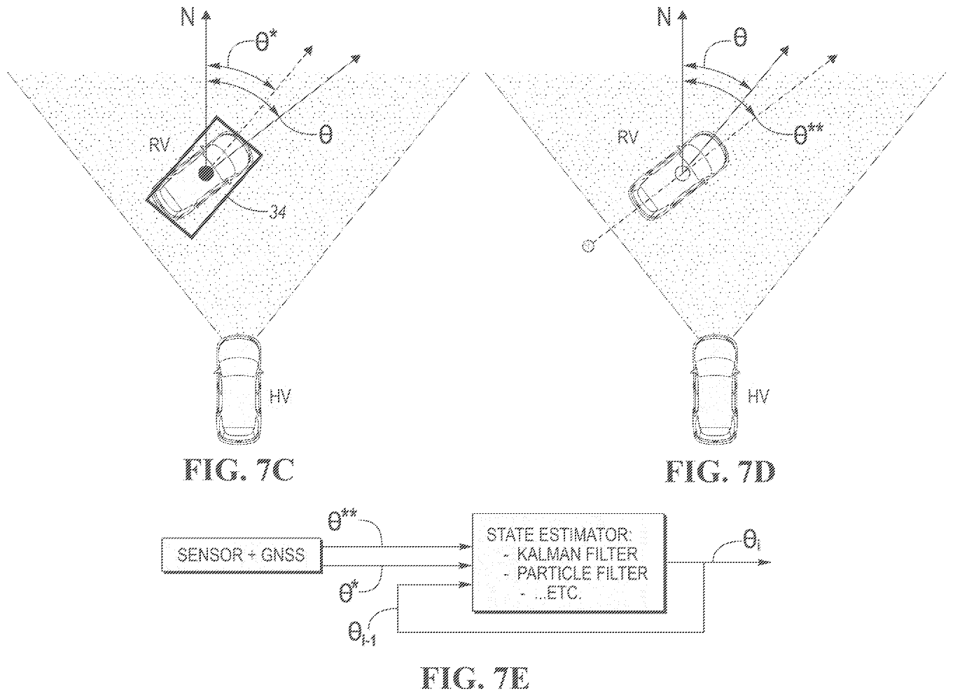

FIGS. 7A-7E are exemplary simplified block diagrams illustrating heading computation for remote objects for collaborative perception among vehicles using V2X communications according to the present disclosure. In that regard, one way to compute the absolute heading of the remote object (remote vehicle, RV) is to use the relative heading of a bounding box 34 of the remote object (if the vision system provides) (see, e.g., FIG. 7B) and the host vehicle heading. Another method involves deriving remote object heading from its path history. Finally, these two methods can be combined using Kalman filter or other sensor fusion function.

In that regard, as seen in FIGS. 7C-7E, e is True heading, θ* is Heading from sensor, and θ** is Heading from coordinates. As seen in FIG. 7C, the host vehicle vision system sensor may build a bounding box 34 around the remote vehicle RV. The remote vehicle orientation in addition to the host vehicle HV heading may be used to calculate the remote vehicle heading. Such a method, however, may be prone to errors associated with the sensor bounding box algorithm and host vehicle GNSS data. As seen in FIG. 7D, the host vehicle HV may construct coordinates for the remote vehicle RV using distance measurement from sensor and the host vehicle GNSS measurements. Consecutive RV coordinates may be used to calculate the heading of the remote vehicle RV. Such a method, however, may be prone to errors associated with sensor distance measurement, HV GNSS data, and curves. As seen in FIG. 7E, using a state estimator, such as a Kalman filter or Particle filter, current measurements sources (measurement) θ* and θ** can be used with a prior state (Priori), ϵᵢ₋₁, and senor covariance to calculate new state (Posterior), θᵢ.

More specifically, for heading calculation using consecutive GNSS coordinates, a CP object heading may be calculated from consecutive location coordinates in degrees (Coord_1 and Coord_2). In that regard, Coord_m may consist of lat1 and long1. Coord_m+1 may consist of lat2 and long2. The exemplary Python function set forth below may serve as a reference on how to perform this calculation. Such a calculation may alternatively be performed, implemented, and/or illustrated in or by any programming language and/or pseudocode known to those of ordinary skill.

```
import math
import numpy
def BfromGPS(lat1 ,long1, lat2, long2):
  R=6.371*math.pow(10,6) #earth radius
  lat1_ =lat1*math.pi/180 #convert degrees into radians
  lat2_ =lat2*math.pi/180
  long1_ =long1*math.pi/180
  long2_ =long2*math.pi/180
  y = numpy.array(R*(lat2_−lat1_))
  x = numpy.array(R*(long2_−long1_)*numpy.cas(lat1_))
    b= numpy.arctan2(x, y)*180/math.pi
  return b
```

When a new coordinate point, Coord_m+2, arrives, if the distance between Coord_m+2 and the last point used in calculation, Coord_m+1, is greater than a threshold value, HeadCalc_Dist_M, then the heading of the new BSM transmission shall be updated to the heading value calculated using Coord_m+1 and Coord_m+2. In that regard, the exemplary Python function set forth below may serve as a reference on how to perform the distance calculation using latitudes and longitudes in degrees. Such a calculation may alternatively be performed, implemented, and/or illustrated in or by any programming language and/or pseudocode known to those of ordinary skill.

```
from math import radians, cos, sin, asin, sqrt, atan2, pi
def distance(lat1, long1, lat2, long2):
  p = pi/180
  a = 0.5 − cos((lat2−lat1)*p)/2 + cos(lat1*p) * cos(lat2*p) *
  (1−cos((long2−long1)*p))/2
  return 12742 * asin(sqrt(a)) *1000 #2*R*asin...
```

Alternatively, if the distance between Coord_m+2 and Coord_m+1 is less than HeadCalc_Dist_M, then the previously calculated heading shall be latched and used in future BSM transmissions until coordinate point Coord_m+n arrives with distance to Coord_m+1 greater than HeadCalc_Dist_M. At that point, the heading for new BSM transmissions shall be updated and calculated using Coord_m+1 and Coord_m+n.

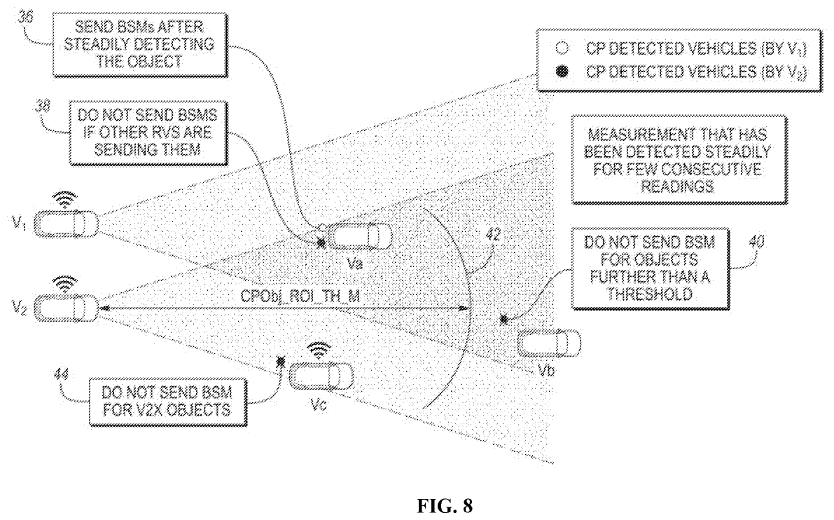

Referring now to FIG. 8, an exemplary simplified block diagram illustrating collaborative perception stability and Basic Safety Message (BSM), surrogate BSM, Cooperative/Collaborative/Collective Perception Message (CPM), or any other standardized message (e.g., Cooperative Awareness Message (CAM)) duplication avoidance according to the present disclosure is shown. In that regard, such a filter may be configured to suppress BSM transmission for vehicles that are equipped with V2X radio and are already transmitting BSMs, discard Collaborative Perception data for faraway objects, and/or ensure stability of received Collaborative Perception objects by waiting for multiple detections of the same object before processing it into a BSM. In general, as seen in FIG. 8, vehicles V₁ and V2 are equipped with V2X and sensor systems. Vehicle V₁ may send proxy-BSMs for a vehicle Va which does not include a V2X communication system after steadily detecting the vehicle Va for a threshold number of consecutive readings 36. Vehicle V2 does not send 38 proxy-BSMs for vehicle Va if another remote vehicle (e.g., vehicle V₁) is already sending proxy-BSMs on behalf of vehicle Va. Moreover, vehicle V₂ (as well as vehicle V₁) does not send 40 proxy-BSMs for vehicle Vb which does not include a V2X communication system when vehicle Vb is located at a distance from vehicle V2 greater than a threshold distance 42. Furthermore, vehicle V2 does not send 44 proxy-BSMs for vehicle Vc which is equipped with a V2X communication system and therefore sends its own BSMs.

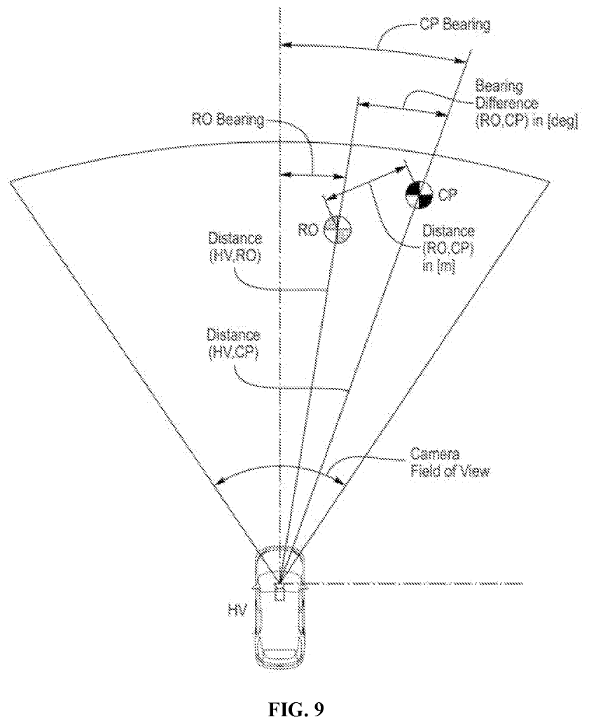

FIG. 9 is an exemplary simplified block diagram illustrating a V2X BSM generated remote object position in comparison to a Collaborative Perception (CP) Perceived Object Container (POC) according to the present disclosure. As seen therein, Remote Object (RO) is a V2X object, and Collaborative Perception (CP) is an object detected with a vision system on-board a host vehicle HV. According to the present disclosure, positions from Remote Objects (RO) V2X (BSMs) generated position and Collaborative Perception (CP) generated positions (proxy BSMs) may be compared. In that regard, FIG. 9 illustrates (i) a camera field of view for a host vehicle fly, (ii) RO and CP bearings, including a bearing difference between the RO and CP bearings (in degrees); and (iii) distances from the HV to RO and CP, respectively, as well as a distance between RO and CP (in meters).

More specifically, the collaborative perception system and method of the present disclosure may provide a collaborative perception (CP) stability and BSM duplications avoidance algorithm as follows:

1. When a new CP object data is received, the object shall be discarded if the absolute distance between the Host Vehicle (HV) and the object is greater than CPObj_ROI_TH_M (with a default value of 100 meters). Otherwise, the CP object data shall be passed to step 2

2. A counter for the received object ID Rcvd_CPObj_CTR shall be incremented by 1.

3. Each time Rcvd_CPObj_CTR is incremented, the current time shall be saved in (overwrite) the Rcvd_CPObj_Timestamp.

4. The following check shall be performed at a frequency of 20 Hz: If the current time is greater than (Rcvd_CPObj_Timestamp+350 milliseconds), both Rcvd_CPObj_Timestamp and Rcvd_CPObj_CTR shall be reset to zero.

5. If Rcvd_CPObj_CTR is less than Rcvd_CPObj_CTR_TH (with a default value of 2), the object data shall be discarded.

6. If Rcvd_CPObj_CTR is greater than or equal to Rcvd_CPObj_CTR_TH, the object data shall be passed to step 7.

7. Maintain the incoming CP object's data from step 6 in a list called Rcvd_CPObj. The CP object data shall be deleted from the list after configurable RV_CPObj_timer_MS (with default value of 350 milliseconds) of its reception, or when a new CP object with the same ID is received from step 5.

8. The received object data shall be discarded if there is another object data with a different ID in Rcvd_CPObj with a distance to the newly detected object of less than CPtoCPDist_TH_M (with a default value of 4 meters)

9. The CP object data that pass the previous step shall be buffered for configurable CP_data_timer_MS (with default value of 50 milliseconds.)

10. Maintain the incoming BSMs from V2X equipped Remote Vehicles (RVs) in a list called Rcvd_BSMs. The BSM shall be deleted from the list after configurable RV_BSM_timer_MS (with default value of 110 milliseconds) of its reception, or when a new BSM from the same RV is received.

11. After the CP_data_timer expires, the distance in meters (CPtoV2X_Dist_M) between the coordinates of the CP object from step 9 and coordinates in all the BSMs in Rcvd_BSMs shall be calculated. The exemplary Python implementation set forth below may serve as a reference on CPtoV2X_Dist_M calculation. Such a calculation may alternatively be performed, implemented, and/or illustrated in or by any programming language and/or pseudocode known to those of ordinary skill.
from math import radians, cos, sin, a sin, sqrt, a tan2, pi
def distance (lat1, long1, lat2, long2):

p=pi/180

a=0.5−cos((lat2−lat1)*p)/2+cos(lat1*p)*cos(lat2*p)*(1−cos((long2−long1)*p))/2 return 12742*a sin(sqrt(a))*11000 #2*R*a sin . . .

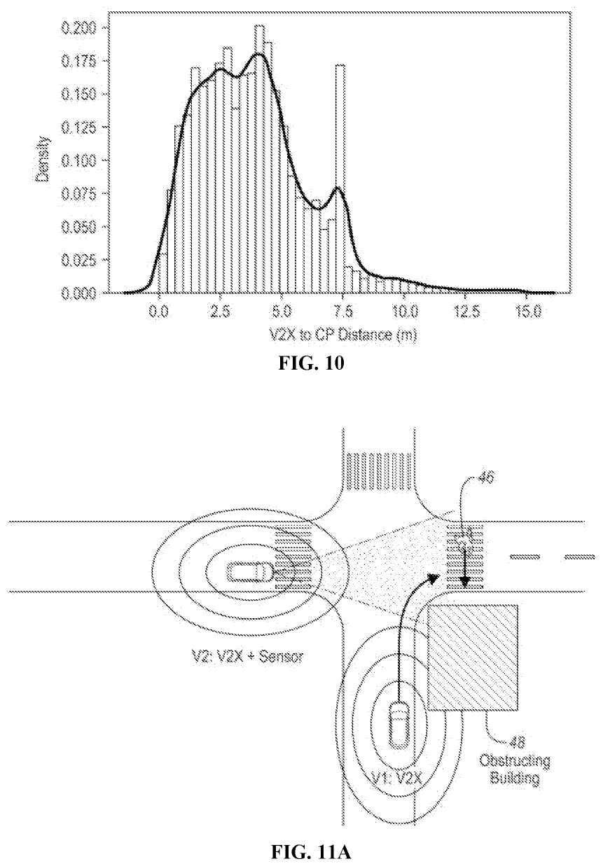

12. If CPtoV2X_Dist_M for any of the BSMs in Rcvd_BSMs is less than CPtoV2XDist_TH_M (with default value of 4 meters), the CP BSM shall NOT be transmitted. CPtoV2XDist_TH_M value selection presents a tradeoff. A high value results in suppressing CP BSMs based on V2X BSM from RVs adjacent to the one being detected by CP. A low value risks failing data association between the CP data and the BSM from the same object. The default value of CPtoV2XDist_TH_M was selected by inspecting real-world CP test data. The default value was selected to be slightly higher than the mean distance between the CP data and the BSM data for the same vehicle. In that regard, FIG. 10 is an exemplary graph of Collaborative Perception (CP) to V2X distance data from such a test.

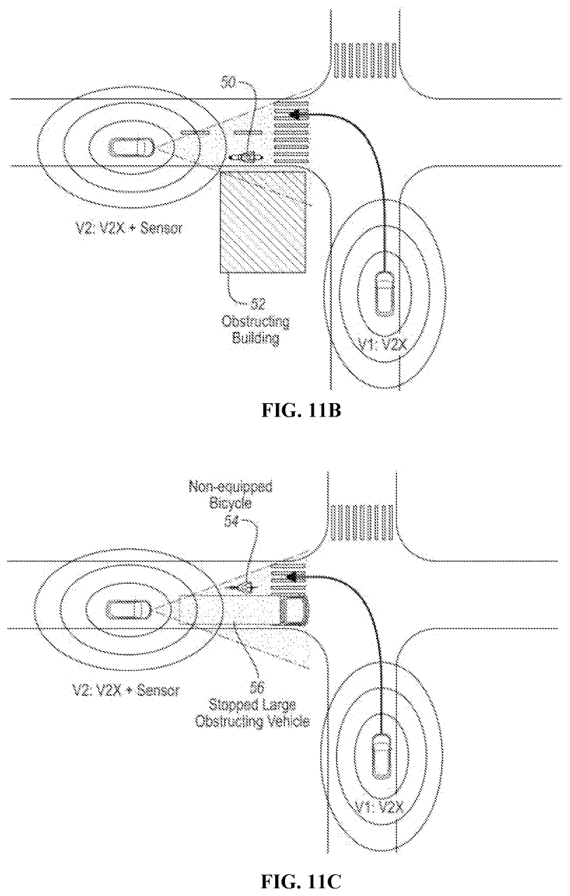

FIGS. 11A-11C are exemplary simplified block diagrams illustrating exemplary vulnerable road user (VRU) scenarios according to the present disclosure. More specifically, FIG. 11A depicts a pedestrian VRU 46 where vehicle V1 is equipped with a V2X system only while vehicle V2 is equipped with V2X and sensor systems. As seen therein, due to an obstructing building 48, the pedestrian 46 is in a non-line-of-sight (NLOS) position relative to the vehicle V1. According to the collaborative perception system and method of the present disclosure, vehicle V2 detects the pedestrian 46 and sends one or more surrogate Pedestrian Safety Messages (PSMs) or BSM messages on behalf of the pedestrian 46 non-equipped with any V2X communication system. Vehicle V1 receives the surrogate PSM or BSM message and may determine a collision probability with the pedestrian 46 and warn the driver of vehicle V1 if needed.

FIG. 11B depicts a motorcycle VRU 50 where vehicle V1 is equipped with a V2X system only while vehicle V2 is equipped with V2X and sensor systems. As seen therein, due to an obstructing building 52, the motorcycle 50 is in a non-line-of-sight (NLOS) position relative to the vehicle V1. According to the collaborative perception system and method of the present disclosure, vehicle V2 detects the motorcycle 50 and sends one or more surrogate BSM messages on behalf of the motorcycle 50 non-equipped with a V2X communication system. Vehicle V1 receives the surrogate BSM message and may determine a collision probability with the motorcycle 50 and warn the driver of vehicle V1 if needed.

FIG. 11C depicts a bicycle VRU 54 where vehicle V1 is equipped with a V2X system only while vehicle V2 is equipped with V2X and sensor systems. As seen therein, due to an obstructing vehicle 56, the bicycle 54 is in a non-line-of-sight (NLOS) position relative to the vehicle V1. According to the collaborative perception system and method of the present disclosure, vehicle V2 detects the bicycle 54 and sends one or more surrogate BSM messages on behalf of the bicycle 54 non-equipped with a V2X communication system. Vehicle V1 receives the surrogate BSM message and may determine a collision probability with the bicycle 54 and warn the driver of vehicle V1 if needed.

The present disclosure thus describes a system, method, and stored computer executable instructions for collaborative perception among vehicles using V2X communications and/or V2X communication systems. The system may comprise a host vehicle controller or control unit, V2X communication system, and/or sensor systems as described herein, wherein the controller is configured to receive V2X communications, sensor data, and/or other host vehicle data (e.g., position data) and utilize such in the performance of the operations, functions, steps, methods, and/or algorithms described herein, such as remote vehicle heading calculations, vulnerable road user scenario operations, exclusion scenario algorithms, and/or other operations, functions, steps, methods and/or algorithms as described herein, including the execution of stored computer executable instructions to perform such operations, functions, steps, methods, and/or algorithms.

As is readily apparent from the foregoing, various non-limiting embodiments of a system and method for collaborative perception among vehicles using wireless V2X communications have been described. While various embodiments have been illustrated and described herein, they are exemplary only and it is not intended that these embodiments illustrate and describe all those possible. Instead, the words used herein are words of description rather than limitation, and it is understood that various changes may be made to these embodiments without departing from the spirit and scope thereof.

What is claimed is:

1. A system for collaborative perception among vehicles using vehicle-to-everything (V2X) communications, the system comprising:
a V2X communication system to be mounted in a host vehicle;
a sensor system to be mounted in the host vehicle; and
a controller to be mounted in the host vehicle, the controller configured to receive data from the sensor system of the host vehicle and to detect a vulnerable road user based on the received sensor data;
wherein the controller of the host vehicle is further configured to transmit, via the host vehicle V2X communication system, V2X communications based on the received sensor system data to a first remote vehicle equipped with a V2X communication system, the V2X communications comprising information relating to the detected vulnerable road user.

2. The system of claim 1 wherein the vulnerable road user comprises a pedestrian, a motorcycle, or a bicycle.

3. The system of claim 1 wherein the first remote vehicle is incapable of detecting the vulnerable road user or wherein detection of the vulnerable road user by the first remote vehicle is prevented by an obstruction.

4. The system of claim 1 wherein the controller is further configured to receive other data from the host vehicle comprising position and/or heading information relating to the host vehicle and determine position and/or heading information relating to the vulnerable road user based on the position and/or heading information relating to the host vehicle, wherein the information relating to the detected vulnerable road user comprises the determined position and/or heading information relating to the detected vulnerable road user.

5. The system of claim 4 wherein the controller of the host vehicle is further configured to determine, based on received sensor system data and received other data, information relating to a second remote vehicle lacking a V2X communication system and transmit, via the host vehicle V2X communication system, proxy V2X communications on behalf of the second remote vehicle to a third remote vehicle equipped with a V2X communication system, the proxy V2X communications comprising the information relating to the second remote vehicle.

6. The system of claim 5 wherein the controller is further configured to determine position and/or heading information relating to the second remote vehicle based on the position and/or heading information relating to the host vehicle, and wherein the information relating to the second remote vehicle comprises position and/or heading information relating to the second remote vehicle.

7. The system of claim 5 where the controller of the host vehicle is further configured to perform duplication avoidance to prevent the host vehicle from transmitting, via the host vehicle V2X communication system, proxy V2X communications on behalf of the second remote vehicle when
a distance between the host vehicle and the second remote vehicle is greater than a threshold distance,
the distance between the host vehicle and the second remote vehicle has been less than the threshold distance for less than a threshold time period,
the third remote vehicle is located closer to the second remote vehicle than the host vehicle, wherein the third remote vehicle is further equipped with a sensor system, or
the third remote vehicle first transmitted a proxy V2X communication on behalf of the second remote vehicle before the host vehicle, wherein the third remote vehicle is further equipped with a sensor system.

8. A vehicle comprising the system for collaborative perception among vehicles using V2X communications according to claim 1.

9. A method for collaborative perception among vehicles using vehicle-to-everything (V2X) communications, the method comprising:
receiving data from a sensor system mounted in a host vehicle;
detecting a vulnerable road user based on the received sensor data; and
transmitting, via a V2X communication system of the host vehicle, V2X communications based on the received sensor system data to a first remote vehicle equipped with a V2X communication system, the V2X communications comprising information relating to the detected vulnerable road user.

10. The method of claim 9 wherein the vulnerable road user comprises a pedestrian, a motorcycle, or a bicycle, and wherein the first remote vehicle is incapable of detecting the vulnerable road user or detection of the vulnerable road user by the first remote vehicle is prevented by an obstruction.

11. The method of claim 9 further comprising:
receiving other data from the host vehicle comprising position and/or heading information relating to the host vehicle; and
determining position and/or heading information relating to the vulnerable road user based on the position and/or heading information relating to the host vehicle;
wherein the information relating to the detected vulnerable road user comprises the determined position and/or heading information relating to the detected vulnerable road user.

12. The method of claim 11 further comprising:
determining, based on received sensor system data and received other data, information relating to a second remote vehicle lacking a V2X communication system; and
transmitting, via the host vehicle V2X communication system, proxy V2X communications on behalf of the second remote vehicle to a third remote vehicle equipped with a V2X communication system, the proxy V2X communications comprising the information relating to the second remote vehicle.

13. The method of claim 12 further comprising determining position and/or heading information relating to the second remote vehicle based on the position and/or heading information relating to the host vehicle, wherein the information relating to the second remote vehicle comprises position and/or heading information relating to the second remote vehicle.

14. The method of claim 12 further comprising performing duplication avoidance to prevent the host vehicle from transmitting, via the host vehicle V2X communication system, proxy V2X communications on behalf of the second remote vehicle when
a distance between the host vehicle and the second remote vehicle is greater than a threshold distance,
the distance between the host vehicle and the second remote vehicle has been less than the threshold distance for less than a threshold time period,
the third remote vehicle is located closer to the second remote vehicle than the host vehicle, wherein the third remote vehicle is further equipped with a sensor system, or
the third remote vehicle first transmitted a proxy V2X communication on behalf of the second remote vehicle before the host vehicle, wherein the third remote vehicle is further equipped with a sensor system.

15. A non-transitory computer readable medium having stored computer executable instructions for collaborative perception among vehicles using vehicle-to-everything (V2X) communications, including a host vehicle comprising a V2X communication system, a sensor system, and a controller, wherein execution of the instructions causes the controller to:
receive data from the sensor system;
detect a vulnerable road user based on the received sensor data; and
transmit, via the V2X communication system, V2X communications based on the received sensor system data to a first remote vehicle equipped with a V2X communication system, the V2X communications comprising information relating to the detected vulnerable road user.

16. The non-transitory computer readable medium of claim 15 wherein the vulnerable road user comprises a pedestrian, a motorcycle, or a bicycle, and wherein the first remote vehicle is incapable of detecting the vulnerable road user or detection of the vulnerable road user by the first remote vehicle is prevented by an obstruction.

17. The non-transitory computer readable medium of claim 15 wherein execution of the instructions further causes the controller to:
receive other data from the host vehicle comprising position and/or heading information relating to the host vehicle; and
determine position and/or heading information relating to the vulnerable road user based on the position and/or heading information relating to the host vehicle, wherein the information relating to the detected vulnerable road user comprises the determined position and/or heading information relating to the detected vulnerable road user.

18. The non-transitory computer readable medium of claim 17 wherein execution of the instructions further causes the controller to:
determine, based on received sensor system data and received other data, information relating to a second remote vehicle lacking a V2X communication system, and
transmit, via the host vehicle V2X communication system, proxy V2X communications on behalf of the second remote vehicle to a third remote vehicle equipped with a V2X communication system, the proxy V2X communications comprising the information relating to the second remote vehicle.

19. The non-transitory computer readable medium of claim 18 wherein execution of the instructions further causes the controller to determine position and/or heading information relating to the second remote vehicle based on the position and/or heading information relating to the host vehicle, wherein the information relating to the second remote vehicle comprises position and/or heading information relating to the second remote vehicle.

20. The non-transitory computer readable medium of claim 18 wherein execution of the instructions further causes the controller to perform duplication avoidance to prevent the host vehicle from transmitting, via the host vehicle V2X communication system, proxy V2X communications on behalf of the second remote vehicle when
a distance between the host vehicle and the second remote vehicle is greater than a threshold distance,
the distance between the host vehicle and the second remote vehicle has been less than the threshold distance for less than a threshold time period,
the third remote vehicle is located closer to the second remote vehicle than the host vehicle, wherein the third remote vehicle is further equipped with a sensor system, or
the third remote vehicle first transmitted a proxy V2X communication on behalf of the second remote vehicle before the host vehicle, wherein the third remote vehicle is further equipped with a sensor system.
